(19) United States
(12) Patent Application Publication
(10) Pub. No.: US 2018/0067047 A1
(43) Pub. Date: Mar. 8, 2018

(54) RADIATION DETECTOR

(71) Applicant: CANON COMPONENTS, INC., Kodama-gun (JP)

(72) Inventors: Takehiro NAKAMURA, Kodama-gun (JP); Tadashi YASUHARA, Kodama-gun (JP); Ryoichi FUJINO, Kodama-gun (JP)

(21) Appl. No.: 15/680,707

(22) Filed: Aug. 18, 2017

(30) Foreign Application Priority Data
Sep. 5, 2016 (JP) 2016-172904

(51) Int. Cl. G01N 21/64

(52) U.S. Cl. CPC G01N 21/645; G01N 2201/068

(57) ABSTRACT

A radiation detector includes: a phosphor panel including a phosphor excited by entered radiation to emit fluorescence; a light receiving element that photoelectrically converts the fluorescence emitted by the phosphor; and a wiring board provided with the light receiving element, wherein the light receiving element includes a light receiving surface provided with a light receiving portion and an electrode, the phosphor panel and the light receiving element are arranged to face each other, and a surface of the phosphor panel facing the light receiving element and the light receiving surface of the light receiving element are inclined with respect to each other such that a distance between the light receiving portion and the phosphor panel is smaller than a distance between the electrode and the phosphor panel.

### CROSS-REFERENCE TO RELATED APPLICATIONS

This application is based upon and claims the benefit of priority of the prior Japanese Patent Application No. 2016-172904, filed on Sep. 5, 2016, the entire contents of which are incorporated herein by reference.

### BACKGROUND OF THE INVENTION

### Field of the Invention

The present invention relates to a radiation detector. Particularly, the present invention relates to a radiation detector including: a phosphor that emits fluorescence based on entered radiation; and a light receiving element that receives the fluorescence emitted by the phosphor.

### Description of the Related Art

There is a radiation detector including: a phosphor layer that emits light based on entered radiation; and a light receiving element that detects the light emitted by the phosphor layer, wherein the radiation is converted to the light to detect the radiation. Patent Document 1 discloses a configuration including: a phosphor layer excited by entered radiation to emit fluorescence; and a substrate provided with a light receiving element that receives the fluorescence emitted by the phosphor layer to convert the fluorescence to an electric signal, wherein the phosphor layer is laminated on the substrate. In the radiation detector, it is preferable that the distance between the phosphor layer and the light receiving element be reduced to increase the sensitivity of radiation detection and the spatial resolution of a radiograph to be output.

There is a light receiving element including an electrode for electrically connecting the light receiving element and the outside, the electrode provided on a same surface as a light receiving portion that detects entered light. For example, there is a surface-mount light receiving element including a light receiving portion and an electrode on the same surface. When the light receiving element is electrically connected to a substrate through wiring, such as a bonding wire and an FPC, the wiring protrudes from the same surface as a photodetector. Therefore, the phosphor and the wiring interfere with each other, and it is difficult to reduce the distance between the phosphor and the light receiving element.

Patent Document 1

Japanese Laid-open Patent Publication No. 2016-20820

### SUMMARY OF THE INVENTION

In view of the circumstances, an object of the present invention is to reduce a distance between a phosphor and a light receiving element in a radiation detector including a light receiving element electrically connected to a substrate through wiring.

To attain the object, the present invention provides a radiation detector including: a phosphor panel including a phosphor that emits fluorescence when radiation enters; a photoelectric conversion unit that photoelectrically converts the fluorescence emitted by the phosphor; and a wiring board provided with the photoelectric conversion unit, wherein the photoelectric conversion unit includes a light receiving surface provided with: a light receiving portion that receives the fluorescence emitted by the phosphor; and an electrode electrically connected to the wiring board, the phosphor panel and the photoelectric conversion unit are arranged to face each other, and a surface of the phosphor panel facing the photoelectric conversion unit and the light receiving surface of the photoelectric conversion unit are inclined with respect to each other such that a distance between the light receiving portion and the phosphor panel is smaller than a distance between the electrode and the phosphor panel.

### BRIEF DESCRIPTION OF THE DRAWINGS

FIG. 1 is an exploded perspective view schematically illustrating a configuration example of a radiation detector according to a first embodiment of the present invention;

FIG. 2 is an external perspective view schematically illustrating the configuration example of the radiation detector according to the first embodiment of the present invention;

FIG. 3 is a sectional view schematically illustrating the configuration example of the radiation detector according to the first embodiment of the present invention;

FIG. 4 is a view schematically illustrating a positional relationship between a phosphor panel and photodiode arrays;

FIG. 5 is a view schematically illustrating the positional relationship between the phosphor panel and the photodiode arrays;

FIG. 6 is a sectional view schematically illustrating a configuration example of a radiation detector according to a second embodiment; and

FIG. 7 is a sectional view schematically illustrating a configuration example of a radiation detector according to a third embodiment.

### DETAILED DESCRIPTION OF THE PREFERRED EMBODIMENTS

Embodiments of the present invention will now be described in detail with reference to the drawings. A radiation detector according to the embodiments of the present invention is used by directing one side of the radiation detector toward an inspection target and a radiation source. The radiation detector detects radiation radiated from the radiation source and transmitted through the inspection target and generates and outputs a radiographic signal (image data) based on a detection result. For the convenience of the description, three-dimensional directions of the radiation detector will be indicated by arrows of X, Y, and Z in the drawings. The X direction is a longitudinal direction, and the Y direction and the Z direction are transverse directions perpendicular to each other. In the embodiments of the present invention, the X direction is a main-scan direction, the Y direction is a sub-scan direction, and the Z direction is a vertical direction. As for the Z direction, one side for receiving the radiation (one side directed toward the radiation source during the use) is an upper side, and the opposite side is a lower side. In the drawings, the optical axis of the entering radiation is indicated by an alternate short and long dash line L.

### First Embodiment

(Overall Configuration)

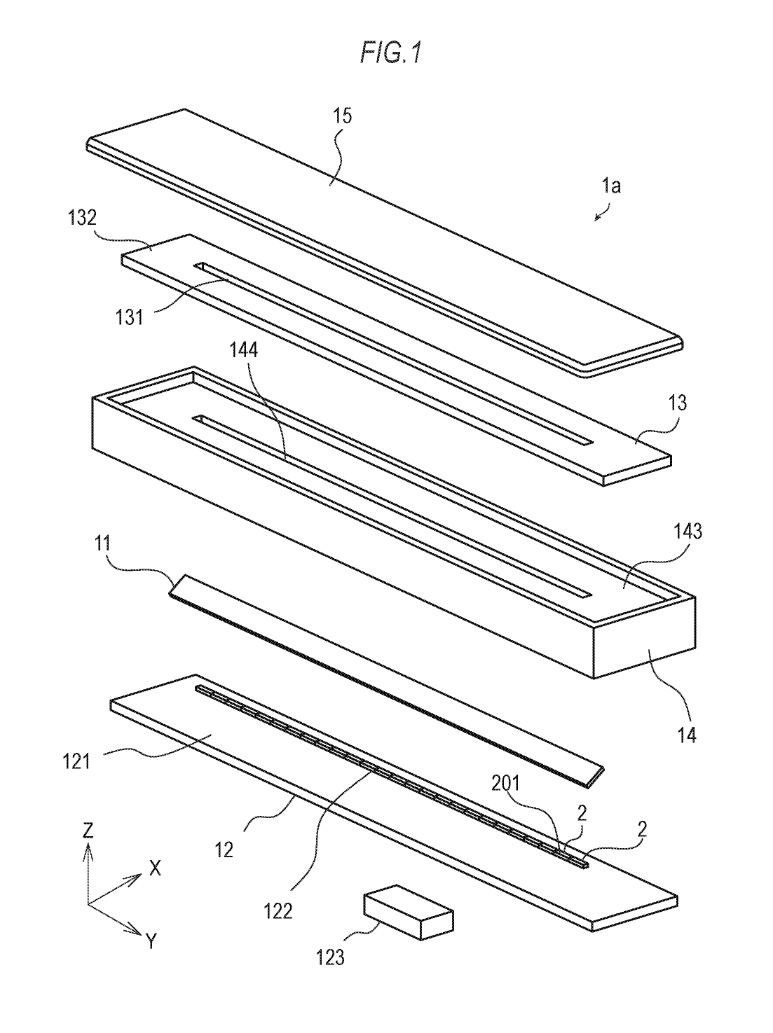

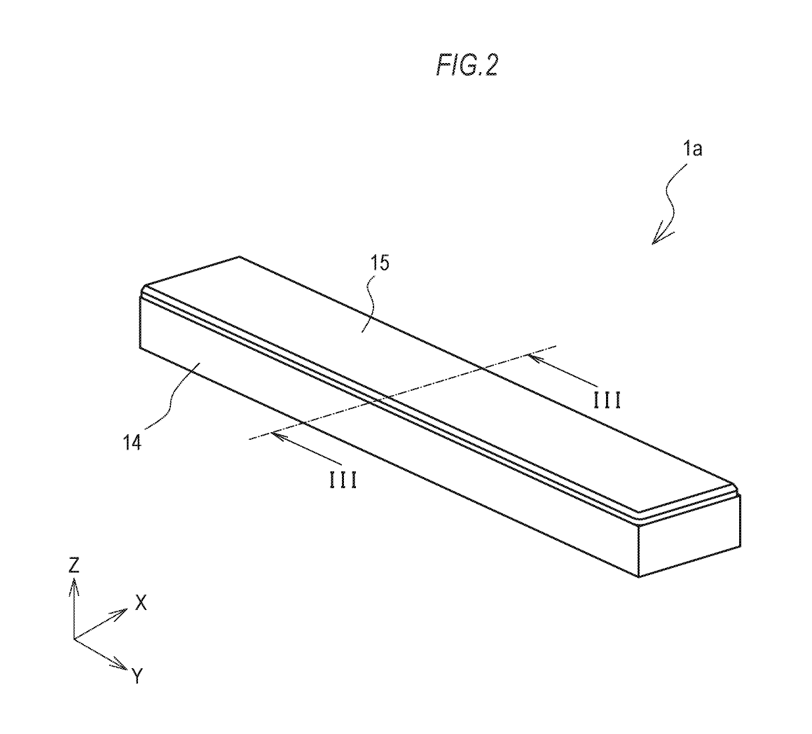

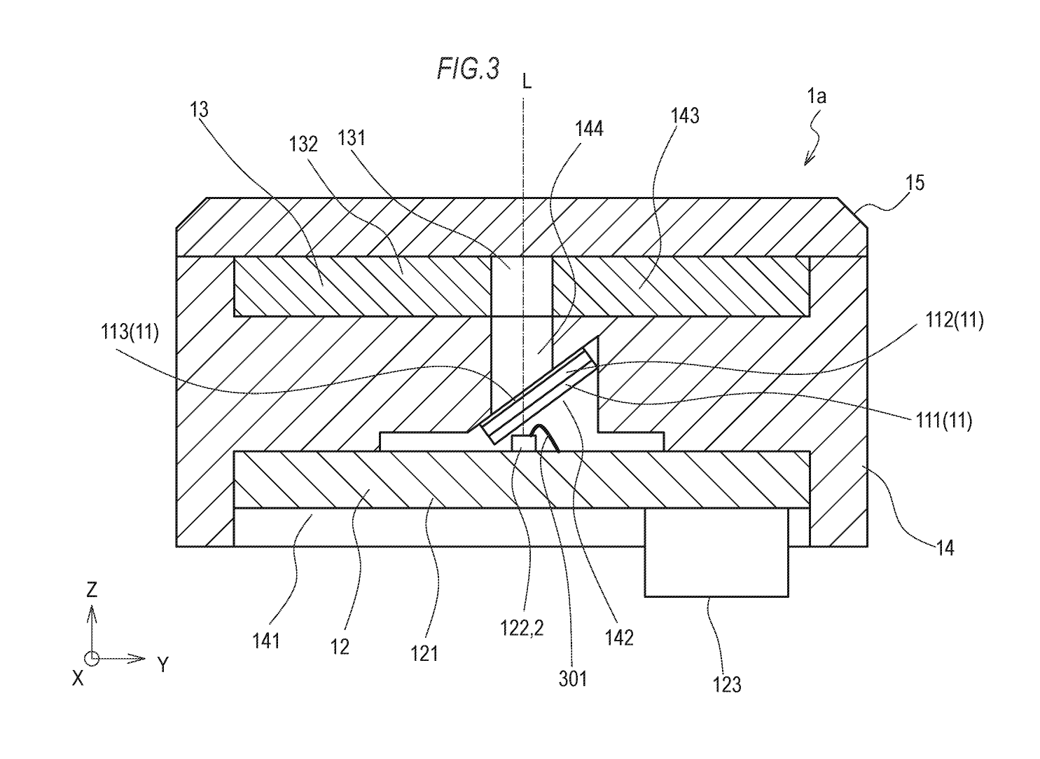

First, an example of a configuration of a radiation detector 1a according to a first embodiment will be described with reference to FIGS. 1 to 3. FIG. 1 is an exploded perspective view schematically illustrating a configuration example of the radiation detector 1a according to the first embodiment. FIG. 2 is an external perspective view schematically illustrating the configuration example of the radiation detector 1a according to the first embodiment. FIG. 3 is a sectional view taken along line of FIG. 2 and is a view schematically illustrating an example of a sectional configuration of the radiation detector 1a according to the first embodiment. As shown in FIGS. 1 to 3, the radiation detector 1a includes a phosphor panel 11, a sensor substrate 12, a blocking member 13, a body frame 14, and a body cover 15.

The phosphor panel 11 includes a phosphor layer 112 that emits fluorescence when the radiation enters, and the phosphor panel 11 has an elongated plate shape as a whole. For example, the phosphor panel 11 includes: a base layer 111; the phosphor layer 112 provided on one surface of the base layer 111; and a reflector layer 113 provided to cover a surface of the phosphor layer 112. In this case, the base layer 111 can be a plate or a sheet made of a transparent material (material with a high transmittance of visible light), such as polyethylene terephthalate (PET). The phosphor layer 112 can be made of a material, such as gadolinium oxysulfide (GoS), excited to emit visible light when the radiation enters. The reflector layer 113 can be made of a material, such as alumina and calcium carbonate, with a high reflectance of visible light and a high transmittance of radiation.

The phosphor panel 11 is not limited to a specific configuration as long as the phosphor panel 11 includes the phosphor layer 112 and has an elongated plate shape as a whole. For example, other than gadolinium oxysulfide, the phosphor may be cesium iodide (CsI) or amorphous selenium (a-Se). The base layer 111 is not limited to polyethylene terephthalate, and the base layer 111 can be made of various resin materials or glass. The reflector layer 113 can be any material with a high reflectance of visible light and a high transmittance of radiation. When the phosphor layer 112 is made of a deliquescent material, it is further preferable that the phosphor panel 11 be provided with a protective layer that covers the phosphor layer 112 to suppress deliquescence. In this case, the protective film can be made of a material with high water-shielding and water-repellent properties, such as a fluorine-based resin.

The sensor substrate 12 includes a wiring board 121 and an image sensor 122 provided on the upper surface of the wiring board 121.

The wiring board 121 has an elongated plate shape. One surface of the wiring board 121 (surface facing the phosphor panel 11) is provided with a predetermined number of pads 302 for electrical connection with photodiode arrays 2 described later. In addition, the wiring board 121 is provided with a predetermined wiring pattern (not shown). The configuration of the wiring pattern provided on the wiring board 121 is appropriately set according to the configuration and the like of the photodiode arrays 2 to be mounted, and the configuration is not specifically limited.

The image sensor 122 is an example of a photoelectric conversion unit and is configured to photoelectrically covert the fluorescence (visible light) emitted by the phosphor layer 112 of the phosphor panel 11. The image sensor 122 can be a light receiving element (may also be called a photoelectric conversion element). Here, the photodiode arrays 2 are illustrated as an example of the light receiving element. The photodiode arrays 2 that can be applied in the embodiments of the present invention are provided with: a plurality of light receiving portions 21 one-dimensionally arranged in a predetermined direction; and a predetermined number of electrodes 22 for electrical connection with the outside. The plurality of photodiode arrays 2 are lined up and mounted in the longitudinal direction (main-scan direction) on one surface of the wiring board 121 of the sensor substrate 12 (surface facing the phosphor panel 11 when assembled to the body frame 14). In this way, the plurality of photodiode arrays 2 lined up and mounted in the longitudinal direction form the image sensor 122 that is an example of the photoelectric conversion unit. Specific configuration example and mount structure of the photodiode arrays 2 will be described later.

A connector 123 for electrical connection with the outside may be provided on the surface opposite the side provided with the image sensor 122 of the wiring board 121. In this case, the configuration of the connector 123 is not particularly limited, and various well-known connectors can be applied. The wiring board 121 may be further provided with a circuit or the like that controls the image sensor 122.

The blocking member 13 is a member that prevents the radiation from entering the part other than the phosphor panel 11. The blocking member 13 includes: a transmission area 131 that is long in the longitudinal direction of the wiring board 121 as viewed in the vertical direction; and a blocking area 132 provided to surround the transmission area 131. The transmission area 131 and the blocking area 132 have different transmittances of radiation. The transmittance of the transmission area 131 is higher, and the transmittance of the blocking area 132 is lower. It is preferable that the transmittance of radiation in the transmission area 131 be as high as possible, and it is preferable that the transmittance of radiation in the blocking area 132 be as low as possible.

The transmission area 131 is an area serving as a path of radiation entered from the outside. The transmission area 131 is provided at a position where the transmission area 131 appears to overlap with the phosphor panel 11 as viewed in the vertical direction (as viewed in the direction in which the radiation enters) when the blocking member 13 and the phosphor panel 11 are assembled to the body frame 14. In other words, the transmission area 131 is a hole provided on the body frame 14 through which the radiation entering the phosphor panel 11 can pass. Specific dimension and shape of the transmission area 131 are not limited, and the dimension and the shape are appropriately set according to the positions, the dimensions, and the like of the phosphor panel 11 and the image sensor 122.

The blocking member 13 has, for example, a plate-like or block-like configuration made of a material with a low transmittance of radiation and is provided with an elongated slit-like through hole penetrating in the vertical direction. The material with a low transmittance of radiation is, for example, lead. In this case, the slit-like through hole is the transmission area 131, and the other part is the blocking area 132.

The body frame 14 is an example of a housing of the radiation detector 1a. The body frame 14 has, for example, an elongated rectangular solid shape as a whole and is integrally formed by a light-blocking material. The material can be, for example, polycarbonate colored in black. The body frame 14 is provided with: a sensor substrate housing portion 141 that can house the sensor substrate 12; a phosphor panel housing portion 142 that can house the phosphor panel 11; and a blocking member housing portion 143 that can house the blocking member 13.

The sensor substrate housing portion 141 is an area provided closer to the lower side of the body frame 14 and has an elongated concave shape in which the lower side is open. The phosphor panel housing portion 142 is an area provided on the upper side of the sensor substrate housing portion 141 and has an elongated concave shape in which the lower side is open. The blocking member housing portion 143 is an area provided closer to the upper side of the body frame 14 and above the sensor substrate housing portion 141 and the phosphor panel housing portion 142. The blocking member housing portion 143 has an elongated concave shape in which the upper side is open.

The phosphor panel housing portion 142 is provided at a position where the phosphor panel housing portion 142 appears to overlap with both the blocking member housing portion 143 and the sensor substrate housing portion 141 as viewed in the vertical direction. As shown in FIGS. 1 and 3, the blocking member housing portion 143 and the phosphor panel housing portion 142 are connected through an elongated slit-like opening 144 (through hole) penetrating in the vertical direction. The opening 144 serves as a path of radiation from the blocking member housing portion 143 to the phosphor panel housing portion 142. As shown in FIG. 3, the phosphor panel housing portion 142 and the sensor substrate housing portion 141 are integrally connected.

Specific shapes and dimensions of the phosphor panel housing portion 142, the sensor substrate housing portion 141, and the blocking member housing portion 143 are not particularly limited, and the shapes and the dimensions are appropriately set according to the shapes and the dimensions of the phosphor panel 11, the sensor substrate 12, and the blocking member 13 to be housed, respectively.

The body cover 15 is made of a material with a high transmittance of radiation and is a member in a plate shape. The body cover 15 has a function of protecting members, devices, and the like arranged inside of the body frame 14, a function of preventing foreign matters such as dust from entering the body frame 14, and the like. The body cover 15 is not particularly limited to specific shape, dimension, and the like as long as the body cover 15 can be attached to the upper side of the body frame 14 to cover the blocking member housing portion 143.

(Assembly of Radiation Detector)

Next, an assembly configuration of the radiation detector 1a will be described.

The phosphor panel 11 is housed and fixed in the phosphor panel housing portion 142. The phosphor panel 11 is housed and fixed such that the surface (lower surface) facing the sensor substrate 12 is inclined with respect to the vertical direction (optical axis direction of entering radiation) as viewed in the longitudinal direction of the phosphor panel 11. The longitudinal direction of the phosphor panel 11 is parallel to the main-scan direction. When the phosphor panel 11 has a laminate structure of the base layer 111, the phosphor layer 112, and the reflector layer 113, the phosphor panel 11 is housed such that the base layer 111 faces the side (lower side) of the sensor substrate 12 and such that the reflector layer 113 faces the opposite side (upper side).

The plurality of photodiode arrays 2 are mounted on the upper surface of the wiring board 121 of the sensor substrate 12, and the plurality of mounted photodiode arrays 2 form the image sensor 122. Specifically, each of the plurality of photodiode arrays 2 is fixed on the upper surface of the wiring board 121 such that the surface provided with the light receiving portion 21 and the electrode 22 face upward, and the electrode 22 of each of the photodiode arrays 2 and the pad 302 provided on the wiring board 121 are electrically connected through the bonding wire 301. A conventionally well-known wire bonding method can be applied to electrically connect the electrodes 22 of the photodiode arrays 2 and the pads 302 of the wiring board 121. The sensor substrate 12 provided with the image sensor 122 is housed and fixed in the sensor substrate housing portion 141 such that the surface provided with the image sensor 122 faces the phosphor panel 11 housed in the phosphor panel housing portion 142.

The blocking member 13 is housed in the blocking member housing portion 143. When the blocking member 13 is housed in the blocking member housing portion 143, the transmission area 131 of the blocking member 13 and the opening 144 provided on the body frame 14 appear to overlap with each other as viewed in the vertical direction.

The body cover 15 is attached and fixed to the upper side of the body frame 14. The method of fixing the phosphor panel 11, the sensor substrate 12, the blocking member 13, and the body cover 15 to the body frame 14 is not particularly limited. For example, various well-known fixing methods can be applied, such as a fixing method using an adhesive and a method of thermally caulking part of the body frame 14.

(Operation of Radiation Detector)

Next, an operation of the radiation detector 1a will be described. The radiation detector 1a according to the first embodiment is used by arranging the radiation detector 1a to face the radiation source at a predetermined distance so that the radiation radiated from the radiation source enters. The radiation source applies radiation to an inspection target while the inspection target passes between the radiation source and the radiation detector 1a, and the radiation detector 1a detects the radiation.

At least part of the radiation radiated by the radiation source transmits through the inspection target and enters the radiation detector 1a. The radiation entering the radiation detector 1a transmits through the body cover 15 and reaches the blocking member 13. Part of the radiation reaching the blocking member 13 transmits (passes) through the transmission area 131 provided on the blocking member 13 and the opening 144 provided on the body frame 14 and enters the phosphor panel 11. The radiation reaching the blocking area 132 of the blocking member 13 is blocked by the blocking member 13.

The phosphor layer 112 of the phosphor panel 11 is excited to emit fluorescence (visible light) when the radiation enters. The light receiving portions 21 of the photodiode arrays 2 forming the image sensor 122 convert (photoelectrically convert) the fluorescence emitted by the phosphor layer 112 to electric signals. In this case, the fluorescence emitted by the phosphor layer 112 of the phosphor panel 11 is reflected by the reflector layer 113, and this increases the amount of fluorescence entering the light receiving portions 21. Therefore, the detection sensitivity improves. The image sensor 122 outputs the electric signals photoelectrically converted and generated by the light receiving portions 21 at a certain timing as one line of radiographic signals. The radiation detector 1a continuously executes the operation. In this way, the radiation detector 1a generates and outputs a two-dimensional radiograph including internal information of the inspection target.

(Positional Relationship between Photodiode Arrays and Phosphor Panel)

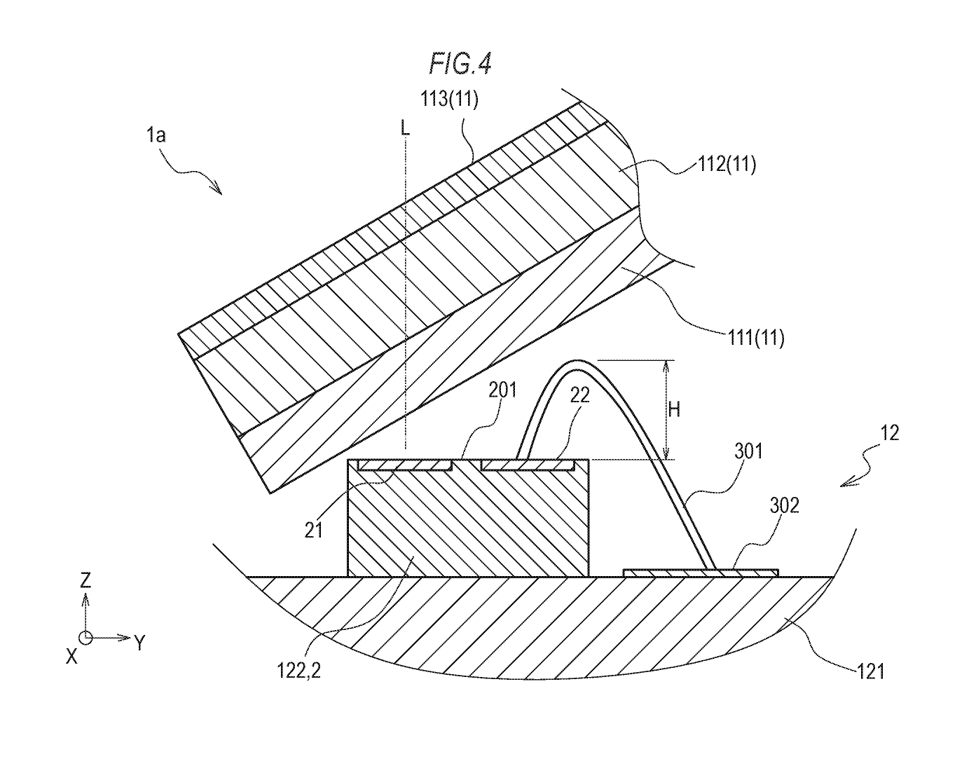

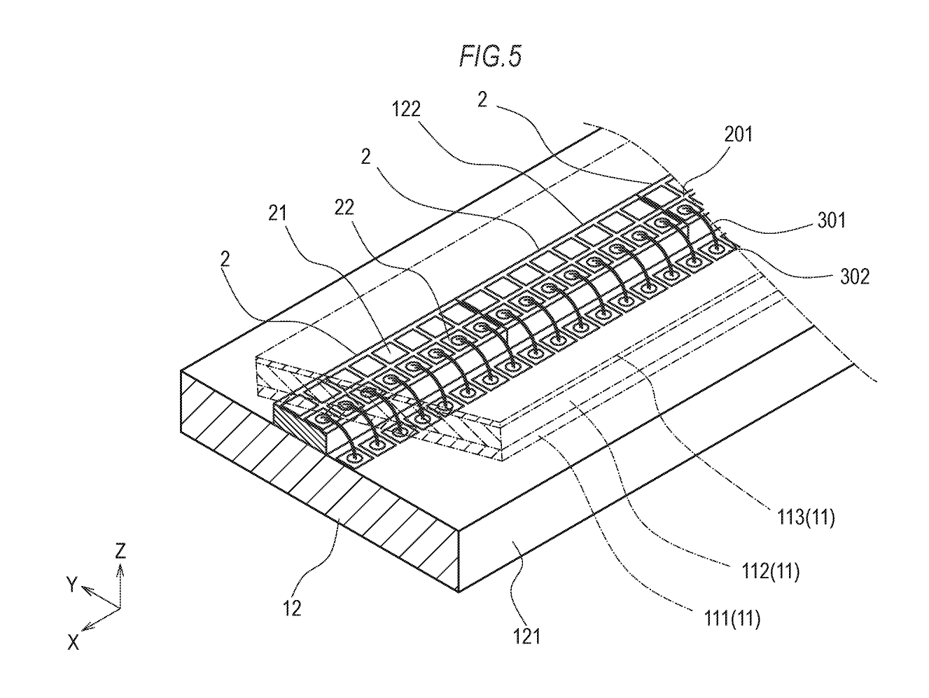

Next, a positional relationship between the photodiode arrays 2 forming the image sensor 122 and the phosphor panel 11 will be described with reference to FIGS. 4 and 5. FIGS. 4 and 5 are views schematically illustrating the positional relationship between the photodiode arrays 2 and the phosphor panel 11. FIG. 4 is a partially enlarged view of FIG. 3, and FIG. 5 is a perspective view seen through the phosphor panel 11.

As shown in FIG. 5, the photodiode arrays 2 have a rod or rectangular solid shape that is long in a predetermined direction. The plurality of light receiving portions 21 are one-dimensionally arranged on the surface of one side of the photodiode arrays 2, and the predetermined number of electrodes 22 are provided. For the convenience of the description, the surface provided with the plurality of light receiving portions 21 and the predetermined number of electrodes 22 will be called a “light receiving surface 201”. The plurality of light receiving portions 21 are provided closer to one of the sides (one side) of the light receiving surface 201 in the transverse direction, and the predetermined number of electrodes 22 are provided closer to the other one of the sides of the light receiving surface 201 in the transverse direction (closer to the side opposite the side provided with the plurality of light receiving portions 21, in other words, the other side). That is, the plurality of light receiving portions 21 and the predetermined number of electrodes 22 are provided closer to the sides opposite to each other in the transverse direction of the light receiving surface 201. In other words, the plurality of light receiving portions 21 are provided along one long side of the light receiving surface 201, and the predetermined number of electrodes 22 are provided along the other long side (opposite long side) of the light receiving surface 201. In the first embodiment, the plurality of photodiode arrays 2 configured in this way are mounted on one surface of the wiring board 121 (surface facing the phosphor panel 11) such that the arrangement direction of the plurality of light receiving portions 21 is parallel to the longitudinal direction (main-scan direction) of the wiring board 121. The plurality of photodiode arrays 2 are lined up and mounted in the longitudinal direction of the wiring board 121. The plurality of mounted photodiode arrays 2 form the image sensor 122 that is an example of the photoelectric conversion unit.

According to the configuration, the light receiving portions 21 of the photodiode arrays 2 are positioned closer to one side in the transverse direction, and the electrodes 22 are positioned closer to the opposite side as viewed in the arrangement direction of the light receiving portions 21, that is, as viewed in the longitudinal direction. All of the photodiode arrays 2 are mounted such that one side provided with the predetermined number of electrodes 22 is positioned on the same side in the transverse direction.

The electrodes 22 of the plurality of photodiode arrays 2 are electrically connected to the pads 302 provided on the surface of the wiring board 121 through predetermined wiring. The bonding wire 301 is applied as the wiring in the example illustrated here. In this case, the bonding wire 301 is drawn out from the electrodes 22 of the photodiode arrays 2 to the side opposite the side provided with the light receiving portions 21 as viewed from the side of the light receiving surface 201 of the photodiode arrays 2, and the bonding wire 301 is connected to the pads 302 of the wiring board 121. That is, the bonding wire 301 is drawn out to one side in the transverse direction of the wiring board 121 (one side in the sub-scan direction in the first embodiment). In all of the photodiode arrays 2, the bonding wire 301 is drawn out to the same side in the transverse direction of the wiring board 121.

When the electrodes 22 of the photodiode arrays 2 and the pads 302 of the wiring board 121 are electrically connected through the bonding wire 301, the bonding wire 301 protrudes from the light receiving surface 201 of the photodiode arrays 2 toward the side facing the phosphor panel 11. Therefore, part of the bonding wire 301 is closer to the phosphor panel 11 than to the light receiving surface 201. A height of protrusion of the bonding wire 301 from the light receiving surface 201 will be called a “loop height” (refer to FIG. 4).

When the distance between the phosphor panel 11 and the photodiode arrays 2 is large, the sensitivity and the spatial resolution are reduced. Particularly, when gadolinium oxysulfide is applied as the phosphor layer 112, the fluorescence emitted by the phosphor layer 112 is diffused light, and the sensitivity and the spatial resolution tend to decrease. Therefore, it is preferable that the distance between the photodiode arrays 2 that are light receiving elements and the phosphor panel 11 be small. However, when the photodiode arrays 2 are applied as the light receiving elements, the area of the light receiving surface 201 is small, and it is difficult to bring the phosphor layer 112 into direct contact with the surface of the light receiving surface 201. Particularly, to obtain a high-resolution radiograph, the dimension of the light receiving portions 21 and the intervals between the light receiving portions 21 are reduced in the photodiode arrays 2 to be applied. However, when the dimension of the light receiving portions 21 and the intervals between the light receiving portions 21 are small, the area of the light receiving surface 201 is also small, and it is more difficult to bring the phosphor layer 112 into direct contact with the surface of the light receiving surface 201. Therefore, in this case, the phosphor panel 11 as a member different from the photodiode arrays 2 that are light receiving elements is arranged on the side where the radiation enters the photodiode arrays 2. However, when the photodiode arrays 2 and the wiring board 121 are electrically connected through the bonding wire 301, the phosphor panel 11 interferes with the bonding wire 301 if the phosphor panel 11 is brought close to the photodiode arrays 2. Therefore, the distance between the phosphor panel 11 and the photodiode arrays 2 cannot be a distance smaller than the loop height H.

Consequently, in the first embodiment, the light receiving surface 201 of the photodiode arrays 2 and the surface of the phosphor panel 11 closer to the photodiode arrays 2 (lower surface in the first embodiment) are inclined with respect to each other, instead of parallel to each other, as viewed in the longitudinal direction. Specifically, the light receiving surface 201 of the photodiode arrays 2 and the lower surface of the phosphor panel 11 are inclined with respect to each other such that the distance between the light receiving portions 21 and the lower surface of the phosphor panel 11 is smaller than the distance between the electrodes 22 and the lower surface of the phosphor panel 11. In the embodiment of the present invention, the photodiode arrays 2 are provided such that the light receiving portions 21 are positioned closer to one side of the light receiving surface 201 in the transverse direction (sub-scan direction) and such that the electrodes 22 are positioned closer to the opposite side in the transverse direction. In this case, the light receiving surface 201 of the photodiode arrays 2 and the lower surface of the phosphor panel 11 are inclined with respect to each other such that the light receiving surface 201 and the lower surface of the phosphor panel 11 are close to each other on one side provided with the light receiving portions 21 and far from each other on the side provided with the electrodes 22 as viewed in the longitudinal direction. The longitudinal direction of the phosphor panel 11 is parallel to the main-scan direction (arrangement direction of the light receiving portions 21).

According to the configuration, the light receiving portions 21 and the phosphor panel 11 can be brought close to each other compared to when the light receiving surface 201 of the photodiode arrays 2 and the lower surface of the phosphor panel 11 are arranged parallel to each other. Particularly, the distance between the surface of the phosphor panel 11 and the light receiving portions 21 of the photodiode arrays 2 can be a distance smaller than the loop height H of the bonding wire 301. On the other hand, the distance between the electrodes 22 and the phosphor panel 11 can be large, and this can prevent contact of the bonding wire 301 and the phosphor panel 11. In this way, the sensitivity and the spatial resolution can be improved (reduction in the sensitivity and the spatial resolution can be prevented or suppressed), while interference between the phosphor panel 11 and the bonding wire 301 is prevented.

As shown in FIGS. 4 and 5, the width (dimension in the transverse direction) of the light receiving surface 201 as viewed in the longitudinal direction (as viewed in the arrangement direction of the light receiving portions 21) of the image sensor 122 (photoelectric conversion unit) is smaller than the width (dimension in the transverse direction) of the lower surface of the phosphor panel 11 (surface facing the light receiving surface 201) as viewed in the vertical direction. The light receiving surface 201 appears to overlap with the lower surface of the phosphor panel 11 as viewed in the vertical direction (falls within the lower surface of the phosphor panel 11 as viewed in the vertical direction).

This can also be applied to the radiation detector 1a including the photodiode arrays 2, in which the dimension of the light receiving portions 21 and the intervals between the light receiving portions 21 are small. Therefore, a radiograph can be generated at a high spatial resolution and a high resolution.

The phosphor panel 11 is arranged to incline with respect to the optical axis (vertical direction) of the entering radiation as viewed in the longitudinal direction. According to the configuration, the radiation enters the phosphor panel 11 in an oblique direction, and this is substantially the same as a configuration in which the phosphor layer 112 is thick. Specifically, when a normal line of the phosphor panel 11 is inclined by an angle θ with respect to the optical axis of radiation, a substantial thickness T_{E} of the phosphor layer 112 is as follows.

T_{E}=T/cosθ

T: thickness of phosphor layer 112 (dimension in normal direction)

Therefore, the amount of fluorescence is increased by an increase in the amount of radiation absorbed by the phosphor layer 112, and the sensitivity can be improved. Since the amount of radiation absorbed by the phosphor layer 112 increases, the amount of radiation reaching the sensor substrate 12 can be reduced, and hit noise can be reduced.

The inclination angle between the phosphor panel 11 and the light receiving surface 201 of the photodiode arrays 2 is not particularly limited. The inclination angle can be appropriately set according to the loop height H and the like of the bonding wire 301. Any configuration can be adopted as long as the interference between the phosphor panel 11 and the bonding wire 301 is prevented (contact is prevented), and as long as the light receiving portions 21 and the phosphor panel 11 are inclined to bring them close to each other.

### Second Embodiment

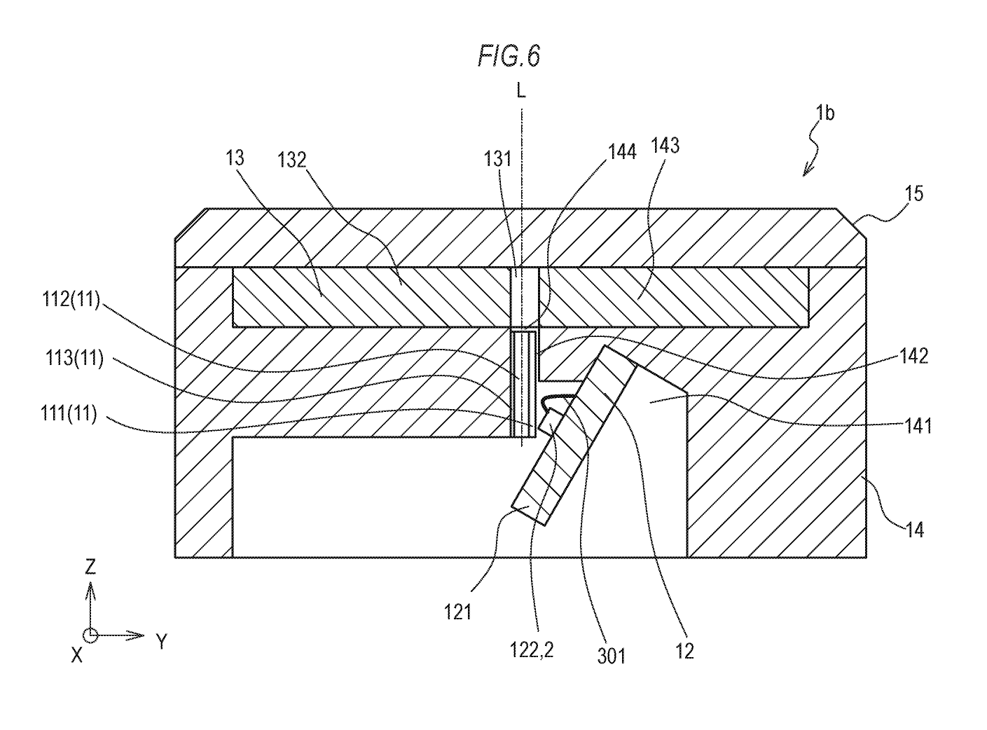

Next, a second embodiment of the present invention will be described with reference to FIG. 6. FIG. 6 is a view schematically illustrating an example of a sectional configuration of a radiation detector 1b according to the second embodiment and is a view corresponding to FIG. 3 of the first embodiment. The same reference signs are provided to the same components as in the first embodiment, and the description will not be repeated.

As shown in FIG. 6, the phosphor panel 11 is arranged such that the short side (transverse direction) is parallel to the optical axis of the entering radiation, and the long side (longitudinal direction) is parallel to the main-scan direction (arrangement direction of the light receiving portions 21). The sensor substrate 12 is arranged such that the light receiving surface 201 of the mounted photodiode arrays 2 is inclined with respect to the optical axis of the entering radiation. The surface of the phosphor panel 11 facing the sensor substrate 12 and the light receiving surface 201 of the photodiode arrays 2 are inclined with respect to each other, instead of parallel to each other, as viewed in the longitudinal direction (as viewed in the arrangement direction of the light receiving portions 21). The mode of the inclination between the phosphor panel 11 and the light receiving surface 201 of the photodiode arrays 2 is the same as in the first embodiment. That is, the light receiving surface 201 of the photodiode arrays 2 and one surface of the phosphor panel 11 (surface facing the photodiode arrays 2) are inclined with respect to each other such that they are close to each other on one side provided with the light receiving portions 21 and are far from each other on one side provided with the electrodes 22 as viewed in the longitudinal direction.

In the second embodiment, the phosphor panel housing portion 142 that houses the phosphor panel 11 is integrally connected to the opening 144. The sensor substrate housing portion 141 that houses the sensor substrate 12 is provided closer to one side of the phosphor panel housing portion 142 in the transverse direction (sub-scan direction). The operation of the radiation detector 1b is the same as in the first embodiment.

According to the configuration, the same advantageous effects as in the first embodiment can be attained. According to the second embodiment, the short side of the phosphor panel 11 is parallel to the optical axis of the entering radiation, and the substantial thickness of the phosphor is maximized. This can increase the advantageous effects of improving the sensitivity and reducing the noise caused by the transmitted radiation.

High-energy radiation (short wavelength radiation) easily enters a deep part of the phosphor layer 112. More fluorescence is emitted by the phosphor layer 112 from the opposite side than from the side close to the part where the radiation enters. Therefore, when high-energy radiation is used, it is preferable that the light receiving portions 21 of the photodiode arrays 2 be arranged to face the lower part of the phosphor panel 11. On the other hand, low-energy radiation (long wavelength radiation) does not easily enter the deep part of the phosphor layer 112. Therefore, more fluorescence is emitted by the phosphor layer 112 from the side close to the part where the radiation enters. Consequently, when low-energy radiation is used, it is preferable that the light receiving portions 21 of the photodiode arrays 2 be arranged to face the upper part of the phosphor panel 11.

In this way, the position of the light receiving portions 21 of the photodiode arrays 2 in the vertical direction (position in the optical axis direction of the entering radiation) may be appropriately set according to the energy of the radiation in the second embodiment. This can improve the sensitivity both in the case of using high-energy radiation and in the case of using low-energy radiation.

### Third Embodiment

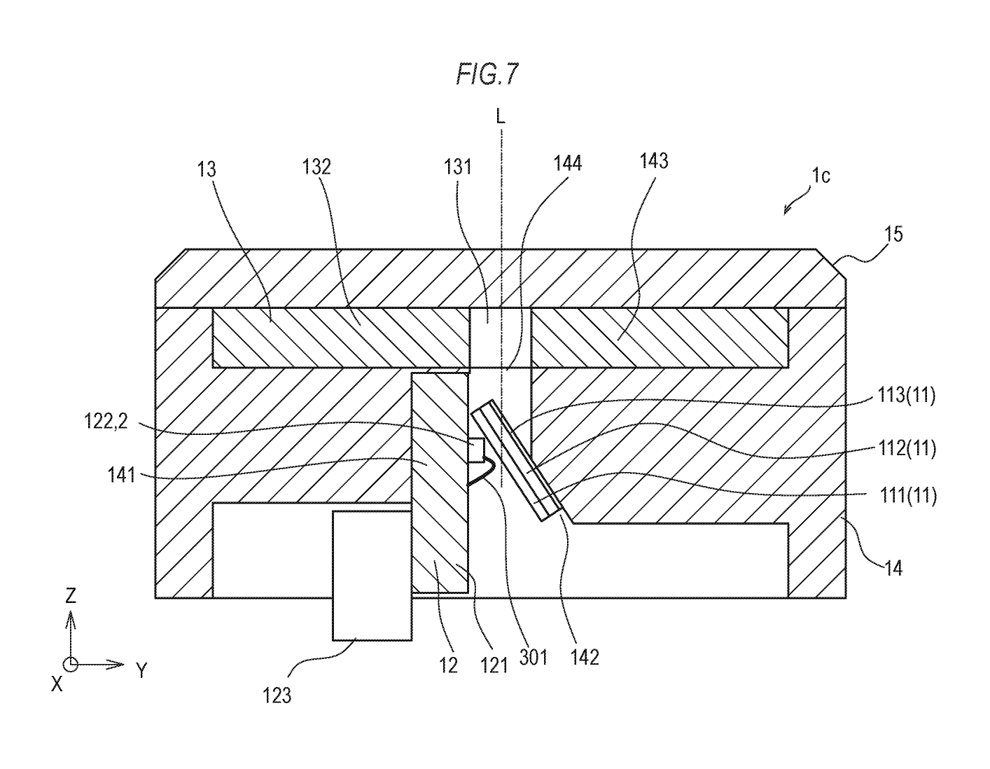

Next, a third embodiment of the present invention will be described. FIG. 7 is a view schematically illustrating an example of a sectional configuration of a radiation detector 1c according to the third embodiment and is a view corresponding to FIG. 3 of the first embodiment. The same reference signs are provided to the same components as in the first embodiment, and the description will not be repeated.

As shown in FIG. 7, the sensor substrate 12 is arranged such that the thickness direction thereof is perpendicular to the optical axis of the entering radiation. The phosphor panel 11 is arranged such that the surface facing the sensor substrate 12 is inclined with respect to the optical axis of the entering radiation. The surface of the phosphor panel 11 facing the sensor substrate 12 and the light receiving surface 201 of the photodiode arrays 2 are inclined with respect to each other, instead of parallel to each other, as viewed in the longitudinal direction. The mode of the inclination between the phosphor panel 11 and the light receiving surface 201 of the photodiode arrays 2 is the same as in the first and second embodiments. It is preferable that the side of the sensor substrate 12 provided with the light receiving portions 21 be positioned on the upper side and that the side provided with the electrodes 22 be positioned on the lower side. It is also preferable that the phosphor panel 11 appear to overlap with the upper side of the image sensor 122 (photodiode arrays 2). According to the configuration, the amount of radiation directly entering the image sensor 122 (photodiode arrays 2) can be reduced.

The sensor substrate housing portion 141 and the phosphor panel housing portion 142 are provided on opposite sides in the transverse direction across the opening 144 as viewed in the vertical direction. It is preferable that the sensor substrate housing portion 141 not appear to overlap with the opening 144 as viewed in the vertical direction. The operation of the radiation detector 1c is the same as in the first embodiment.

According to the configuration, the same advantageous effects as in the first embodiment can be attained. The thickness direction of the wiring board 121 of the sensor substrate 12 is perpendicular to the optical axis of the entering radiation, and the area (projection area) of the sensor substrate 12 as viewed in the vertical direction is small. Furthermore, the wiring board 121 does not have to be arranged on the optical axis of the radiation. Specifically, the wiring board 121 of the sensor substrate 12 can be arranged such that the wiring board 121 appears to overlap with the blocking area 132 of the blocking member 13 and does not appear to overlap with the transmission area 131 as viewed in the vertical direction. This can increase the advantageous effect of reducing the noise caused by the entered radiation.

Although the embodiments of the present invention have been described in detail, the embodiments just illustrate specific examples for carrying out the present invention. The technical scope of the present invention is not limited to the embodiments. The present invention can be changed in various ways without departing from the scope of the present invention.

For example, although the photodiode arrays are the light receiving elements forming the image sensor in the embodiments, the light receiving elements are not limited to the photodiode arrays. The light receiving elements can be any elements that can photoelectrically convert the fluorescence (visible light) emitted by the phosphor layer. The predetermined wiring for electrically connecting the light receiving elements and the wiring board are not limited to the bonding wire. It is only necessary that the wiring be able to electrically connect the electrodes of the light receiving elements and the pads of the wiring board, and the wiring may be, for example, an FPC.

Although the plurality of photodiode arrays are applied as the photoelectric conversion unit, the photoelectric conversion unit is not limited to the plurality of photodiode arrays.

The present invention can be effectively used for a radiation detector including a phosphor layer and an image sensor that detects fluorescence emitted by the phosphor layer. According to the present invention, the spatial resolution can be improved.

According to the present invention, the distance between the phosphor and the light receiving element can be reduced.

What is claimed is:

1. A radiation detector comprising:
a phosphor panel comprising a phosphor that emits fluorescence when radiation enters;
a photoelectric conversion unit that photoelectrically converts the fluorescence emitted by the phosphor; and
a wiring board provided with the photoelectric conversion unit, wherein
the photoelectric conversion unit comprises a light receiving surface provided with: a light receiving portion that receives the fluorescence emitted by the phosphor; and an electrode electrically connected to the wiring board,
the phosphor panel and the photoelectric conversion unit are arranged to face each other, and
a surface of the phosphor panel facing the photoelectric conversion unit and the light receiving surface of the photoelectric conversion unit are inclined with respect to each other such that a distance between the light receiving portion and the phosphor panel is smaller than a distance between the electrode and the phosphor panel.

2. The radiation detector according to claim 1, wherein
a plurality of the light receiving portions are arranged in a predetermined direction in the photoelectric conversion unit, and
the surface of the phosphor panel facing the photoelectric conversion unit and the light receiving surface of the photoelectric conversion unit are inclined with respect to each other as viewed in an arrangement direction of the light receiving portions.

3. The radiation detector according to claim 2, wherein
a longitudinal direction of the phosphor panel is parallel to the arrangement direction of the plurality of light receiving portions, and
a transverse direction of the phosphor panel is parallel to an optical axis of the entering radiation.

4. The radiation detector according to claim 2, wherein
a longitudinal direction of the wiring board is parallel to the arrangement direction of the plurality of light receiving portions, and
a thickness direction of the wiring board is perpendicular to the optical axis of the entering radiation.

5. The radiation detector according to claim 1, wherein
the electrode and the wiring board are electrically connected through a bonding wire.

6. The radiation detector according to claim 5, wherein
a distance between the surface of the phosphor panel and the photoelectric conversion unit is smaller than a loop height of the bonding wire.

7. The radiation detector according to claim 1, wherein
the photoelectric conversion unit is provided on the wiring board, and
the radiation detector further comprises a frame that supports the wiring board and the phosphor panel.

8. The radiation detector according to claim 1, wherein
a width of the light receiving surface of the photoelectric conversion unit as viewed in a longitudinal direction of the photoelectric conversion unit is smaller than a width of the surface of the phosphor panel facing the photoelectric conversion unit as viewed in the longitudinal direction of the photoelectric conversion unit.
